(19) United States
(12) Patent Application Publication
(10) Pub. No.: US 2014/0305532 A1
(43) Pub. Date: Oct. 16, 2014

(54) UNBONDED FLEXIBLE PIPE

(71) Applicant: National Oilwell Varco Denmark I/S, Brondby (DK)

(72) Inventor: Kristian Glejbol, Glostrup (DK)

(73) Assignee: National Oilwell Varco Denmark I/S, Brondby (DK)

(21) Appl. No.: 14/357,365

(22) PCT Filed: Nov. 12, 2012
(86) PCT No.: PCT/DK2012/050415

§ 371 Date: May 9, 2014

(30) Foreign Application Priority Data
Nov. 15, 2011 (DK) PA 2011 00894

(51) Int. Cl. F16L 11/04

(52) U.S. Cl. CPC F16L 11/04
USPC 138/129

(57) ABSTRACT

The invention concerns an unbonded flexible pipe for subsea transportation of fluids, the pipe comprises from inside and outwards a carcass, an inner sealing sheath, a pressure armor, and a tensile armor. The pressure armor comprises at least one helically wound elongate and interlocked element in the form of a strip with a cross-sectional profile comprising a planar mid section and a first and a second interlocking edge configured to have an angle to the planar mid section and to protrude in a direction away from the inner sealing sheath to provide a channel between the first and the second interlocking edges, the pressure armor further comprises at least one helically wound elongate and non-interlocked elongate element where windings of the non-interlocked elongate element are placed at least partly in the channel such that displacement with respect to the helically wound elongate and interlocked element is limited by the first and the second interlocking edges.

### TECHNICAL FIELD

The invention relates to an unbonded flexible pipe for offshore applications, such as an unbonded flexible pipe for transportation of fluids under high pressure or an unbonded flexible pipe for use as umbilical. In particular the unbonded flexible pipe is suitable for subsea transportation of hydrocarboneous fluids.

### BACKGROUND ART

Unbonded flexible pipes of the above type are well known in the art and are for example described in the standard “Recommended Practice for Flexible Pipe”, ANSI/API 17 B, fourth Edition, July 2008, and the standard “Specification for Ubonded Flexible Pipe”, ANSI/API 17J, Third edition, July 2008. Such pipes usually comprise an inner liner also often called an inner sealing sheath or an inner sheath, which forms a barrier against the outflow of the fluid which is conveyed in the bore of the pipe, and one or more armoring layers. In general flexible pipes are expected to have a lifetime of 20 years in operation.

Examples of unbonded flexible pipes are e.g. disclosed in WO0161232A1, U.S. Pat. No. 6,123,114 and U.S. Pat. No. 6,085,799.

The term “unbonded” means in this text that at least two of the layers including the armoring layers and polymer layers are not bonded to each other. In practice the known pipe normally comprises at least two armoring layers located outside the inner sealing sheath. These armoring layers are not bonded to each other directly or indirectly via other layers along the pipe. Thereby the pipe becomes bendable and sufficiently flexible to roll up for transportation.

For many applications a pipe of the above type will need to fulfill a number of requirements. First of all the pipe should have a very high mechanical strength to withstand the forces it will be subjected to during transportation, deploying and in operation. The internal pressure (from inside of the pipe and outwards) and the external pressure (from outside of the pipe) are usually very high and may vary considerably along the length of the pipe, in particular when applied at varying water depths. If the pipe resistance against the internal pressure is too low, the internal pressure may ultimately result in damage of the pipe e.g. by burst of the flexible pipe. If the pipe resistance against the external pressure is too low, the external pressure may ultimately result in deformation and collapse of the inner sealing sheath which acts as the primary barrier towards outflow of a fluid transported in the flexible pipe. Simultaneously the flexible pipe may be subjected to highly corrosive fluids and a high chemical resistance will normally be required. Furthermore, it is desired to keep the weight of the pipe relatively low, both in order to reduce transportation cost and deployment cost but also in order to reduce risk of damaging the pipe during deployment.

In particular for unbonded flexible pipes for use at deep water the combined properties of low weight and high strength are important.

In traditional flexible pipes, the armoring layers often comprise metallic armoring layers including a metal carcass typically wound from preformed or folded stainless steel strips and a number of armoring layers in the form of helically wound profiles or wires, where the individual layers may be wound with different winding angles relative to the pipe axis in order to take up the forces caused by internal and external pressure as well as forces acting at the ends of the pipe and shear forces from the surrounding water.

When subjected to hydrostatic pressure in the sea the carcass of the prior art pipe will usually be designed to be sufficiently strong to withstand the hydrostatic pressure and the armoring layers in the form of helically wound profiles or wires should be designed to be sufficiently strong to withstand internal pressure and tearing in the length direction of the pipe.

In the prior art it has been suggested to replace one or more of the metallic armoring layers with armoring layers of fibers or fiber reinforced polymer of different structures.

In WO 01/51839 an unbonded flexible pipe comprising a tensile armoring layer of fibers, such as aramid fibers embedded in a thermoplastic material is disclosed.

WO 02/095281 discloses a composite reinforcement element for reinforcing an unbonded flexible pipe. The reinforcement element is an elongate flat and layered element of a plurality of strength imparting layers with intermediate layer(s) of thermoplastic.

In “Recommended Practice for Flexible Pipe”, ANSI/API 17 B, fourth Edition, July 2008 it is mentioned that composite materials can be used in the tensile armor layers. The reinforcing fibers used in such composites are E-glass, carbon and aramid fibers. The glass-fiber composite is more economical than the carbon fiber material but the carbon-fiber material has more favorable strength properties and characteristics. For both glass and carbon-fiber composites, the reinforcing fibers are orientated parallel to the wire longitudinal axis.

WO 2009/024156 describes a flexible pipe comprising a plurality of layers surrounding a longitudinal axis of the pipe, including a pressure vault (also called a pressure armoring) arranged on the outer side of an inner sealing sheath. The pressure vault comprises at least one helically wound folded metal strip which is folded along both of its edges to form protruding edge sections of two or more strip material layers, which folded metal strip is interlocked with itself by the folded edge sections in consecutive windings or interlocked with another helically wound and folded metal strip. The pressure vault may comprise a hoop optionally of composite material for increasing the moment of inertia.

The object of the invention is to provide a novel armored flexible pipe, which pipe has a high and durable strength even when subjected to high mechanical stress e.g. during deployment and high production pressure while simultaneously having a high flexibility and suitable weight, and can be manufactured in a cost effective manner compared to state of the art composite armored flexible pipe.

### DISCLOSURE OF INVENTION

This object has been achieved by the present invention as defined in the claims.

The unbonded flexible pipe of the invention and embodiments thereof have shown to have a large number of advantages which will be clear from the following description.

The unbonded flexible pipe is in particular suitable for subsea transporting of fluids either in horizontal direction e.g. as a flow line or in a vertical or mixed vertical/horizontal direction e.g. as a riser and/or jumper. The unbonded flexible pipe is in particular beneficial for use as a riser and it has shown that the unbonded flexible pipe of the invention can be used at deep water even below 1000 m, 2500 m or even deeper. The pipe has a length which is normally about 50 m or longer, preferably at least about 200 m or longer and which may be several kilometers long, such as up to 5 km or even longer.

The unbonded flexible pipe of the invention has shown to have a high and durable strength even when subjected to high mechanical stress e.g. during deployment while simultaneously having a high flexibility and suitable weight, and can be manufactured in a cost effective manner compared to state of the art unbonded flexible pipe.

The flexible unbonded pipe comprises a carcass. The carcass may be any type of carcass which is usable for flexible pipes e.g. as described in Recommended Practice for Flexible Pipe”, ANSI/API 17 B, fourth Edition, July 2008, and the standard “Specification for Ubonded Flexible Pipe”, ANSI/API 17J, Third edition, July 2008. Such carcass is well known in the art.

Usually the carcass will be of metal and the type of metal, the structure and thickness are selected in accordance with the anti-collapse strength required and in accordance with the corrosion resistance required.

The carcass is surrounded by an inner sealing sheath defining a bore in which the fluid, such as hydrocarbons in gas and/or liquid form, can be transported. The inner sealing sheath is the innermost sealing sheath The inner sealing sheath may be any type of inner sealing sheath which is usable for flexible pipes e.g. as described in Recommended Practice for Flexible Pipe”, ANSI/API 17 B, fourth Edition, July 2008, and the standard “Specification for Ubonded Flexible Pipe”, ANSI/API 17J, Third edition, July 2008. Such inner sealing sheaths are well known in the art. Preferred inner sealing sheaths are inner sealing sheath of Poly amide (PA), cross-linked poly ethylene (PEX) and/or high density poly ethylene (HDPE). The inner sealing sheath is usually extruded onto the carcass.

The axis of the pipe is defined as the centre most axis of the bore. Usually the bore will have an essentially circular cross-section, but in an embodiment the cross section is oval in at least a length section of the pipe.

On the outer side of the inner sealing sheath the pipe comprises a pressure armor comprising at least one helically wound elongate element wound with an angle to the axis of about 70 degrees or higher, on the outer side of the pressure armor the pipe comprises a tensile armor comprising a first and a second layer each comprising a plurality of helically wound elongate elements wound with an angle to the axis of about 65 degrees or less, where the first layer of the tensile armor is cross-wound with respect to the second layer of the tensile armor.

The tensile armor may be any type of tensile armor which is usable for flexible pipes e.g. as described in Recommended Practice for Flexible Pipe”, ANSI/API 17 B, fourth Edition, July 2008, and the standard “Specification for Ubonded Flexible Pipe”, ANSI/API 17J, Third edition, July 2008. Such tensile armors are well known in the art.

Preferred tensile armors are as described in U.S. Pat. No. 6,165,586, WO 01/51839, DK PA 2011 00334 and/or DK PA 2010 01108.

In a preferred embodiment the helically wound elongate elements of the tensile armor are of or comprise fiber reinforced polymer, the fibers are preferably continuous fibers arranged along the length of the respective elongate elements of the tensile armor. The continuous fibers can for example be as the continuous fibers described below.

The pressure armor comprises at least one helically wound elongate and interlocked element in the form of a strip with a cross-sectional profile comprising a planar mid section and a first and a second interlocking edge configured to have an angle to the planar mid section and to protrude in a direction away from the inner sealing sheath to provide a channel between the first and the second interlocking edges.

The term “the first and the second interlocking edges of the strip” is herein used to designate the edge part adjacent to the planar mid section, whereas the border(s) of the edge(s) designates the absolute border(s).

A helically wound elongate and interlocked element—also referred to as an interlocked elongate element—is herein defined as a helically wound elongate element where adjacent windings of the interlocked elongate element or of another helically wound elongate and interlocked element are interlocked with each other to limit displacements in a direction along the length of the pipe. Thereby gaps between the windings of the helically wound elongate and interlocked element(s) are limited to a selected maximum size. This interlocking effect ensures that the unbonded flexible pipe can have a suitable flexibility while simultaneously having a low risk or degree of creep of the inner sealing sheath into gaps between the windings of the helically wound elongate and interlocked element(s). If the gaps become too large and an uncontrolled creep of the inner sealing sheath into gaps between the windings of the helically wound elongate and interlocked element(s) occurs, this will both result in a reduced strength of the pipe as well as a reduced flexibility of the pipe. Therefore it is important that the gaps between the windings of the helically wound elongate and interlocked element(s) are kept within selected minimum and maximum (normally referred to as ‘the play’).

The pressure armor further comprises at least one helically wound elongate and non-interlocked elongate element where windings of the non-interlocked elongate element are placed at least partly in the channel such that displacement with respect to the helically wound elongate and interlocked element is limited by the first and the second interlocking edges.

A helically wound elongate and non-interlocked element—also referred to as a non-interlocked elongate element—is herein defined as a helically wound elongate element where adjacent windings of the non-interlocked elongate element or of another helically wound elongate and non-interlocked element are not interlocked with each other to limit displacements in a direction perpendicular to the winding direction of the helically wound elongate and non-interlocked element(s). Accordingly, the non-interlocked elongate element(s) does/do not have any function in limiting the play between non-interlocked windings.

As it will be described below the non-interlocked elongate element(s) can be laterally engaged. Such lateral engagement has the function of limiting any radial displacements of windings of non-interlocked elongate element(s) but without limiting the movement along the length the pipe.

The pressure armor of the pipe can thereby be produced in a very cost effective manner. The interlocked elongate element is in the form of a strip which in a simple manner can be folded or shaped to have a cross-sectional profile comprising a planar mid section and a first and a second interlocking edge. Furthermore the invention provides the possibility of using a standard interlocking elongate element for different pipes with different strength requirement and then applying different non-interlocked elongate element(s) onto the interlocked elongate element(s) to thereby obtain a pressure armor with the required strength properties. Also the invention allows for the use of polymer in the pressure armor. So far it has not been desired to use polymer elements in a pressure armor, because such polymer elements cannot provide a safe interlocking to control gaps between windings. The solution provided by the present invention has shown to provide a sufficient control of the gaps between windings and thereby provide a high and durable strength even when subjected to high mechanical stress e.g. during deployment and high production pressure, while simultaneously having a high flexibility. The requirement to the weight of the unbonded flexible pipe can be met by selecting the type, number, thickness and shape of the non-interlocked elongate element(s). Further, as explained above the unbonded flexible pipe can be produced in a cost effective manner compared to state of the art unbonded flexible pipe

In the following the term “elongate element” means elongate element in singular as well as in plural unless it is specifically stated that it is to be interpreted in singular.

In an embodiment of the invention, the windings of the non-interlocked elongate element are held with a predetermined relative distance to each other by the interlocking edges of the helically wound interlocked elongate element(s). The distance between the windings of the non-interlocked elongate element is determined as the maximal distance. In other words if adjacent windings of the non-interlocked elongate element are laterally engaged provided with a protruding flange or similar this protruding flange is disregarded.

The windings of the non-interlocked elongate element are held to have a maximal play with respect to each other by the interlocking edges of the helically wound interlocked elongate element(s). The maximal play is the distance which adjacent windings of the non-interlocked elongate element can travel towards and away from each other.

Accordingly, even though the non-interlocked elongate element is not interlocked, the gap or distance between windings of the non-interlocked elongate element is kept under control, namely by the interlocked elongate element. The non-interlocked elongate element can thereby be provided with any shape, such as a simple rectangular cross sectional shape. Accordingly the unbonded flexible pipe of the invention can be produced in a very cost effective manner.

For simplifying the production it is desired that the strip in its planar mid section has a substantially identical cross-sectional profile along at least a part of its length, preferably along all of its length. In general it is desired that the whole of the strip has a substantially identical cross-sectional profile along at least a part of its length, preferably along all of its length.

As indicated above a simpler way of producing the interlocked elongate element is to provide a flat strip and fold the edges thereof to a desired shape. Such folding can be performed in a simple way by machinery in-line with the helical winding and interlocking of the windings of the interlocked elongate element, in particular if the strip and the folding are constant along the length of the strip.

In an embodiment of the invention the planar mid section of the strip has a first surface facing towards and supporting the inner sealing sheath. By applying the first surface of the mid section towards the inner sealing sheath to support the inner sealing sheath, the interlocked elongate element provides a protection of the inner sealing sheath. The first surface of the mid section can be placed in direct contact with the inner sealing sheath or a film layer, such as an anti wear layer can be applied between the first surface of the mid section and the inner sealing sheath.

The planar mid section has an average thickness determined in radial direction from the axis of the pipe and a width determined over its cross section and perpendicular to its thickness. For simplification of the production the thickness of the plane section is preferably substantially constant over its width.

The thickness of the mid section of the strip is selected so as to obtain a sufficient strength of the interlocking and the forces which it will be subjected to during use of the pipe. The optimal thickness therefore differs in relation to the required strength of the specific unbonded flexible pipe.

In an embodiment of the invention, the planar mid section of the strip has a first surface facing towards and supporting the inner sealing sheath, the planar mid section has an average thickness determined in radial direction from the axis of the pipe, the average thickness is about 5 mm or less, such as about 4 mm or less, such as about 3 mm or less, such as about 2 mm or less, such as from about 0.2 to about 5 mm.

For simplification prior to folding the interlocking edges the whole strip preferably has an even thickness.

In an embodiment of the invention, the interlocking edges are configured to have an angle to the planar mid section by being folded. At least one fold of each edge is required. In an embodiment of the invention, at least one of the edges of the strips has two or more folds.

In an embodiment of the invention, the interlocking edges have angles to the planar mid section of from about 70 degrees to about 110 degrees, preferably from about 80 degrees to about 100 degrees, more preferably from about 85 degrees to about 95 degrees.

In an embodiment of the invention, the interlocking edges do not comprise any folds where a part of an edge is folded against itself. (i.e. such that surface parts of an edge are placed against each other). Such folds against themselves do not add to strength, but merely to weight and to cost. Therefore in most situations such folds against themselves are not desired.

The interlocking edges preferably protrude to a protruding distance of at least 5 times the thickness of the strip at its planar mid section, where the protruding distance is determined as the perpendicular distance to the plan comprising the planar mid section. Preferably the interlocking edges protrude to a protruding distance of at least about 3 mm, more preferably at least about 5 mm, more preferably at least about 8 mm.

In an embodiment of the invention at least one of the first and the second interlocking edges of the strip comprises slits or cuts extending from a border of the edge towards the planar mid section of the strip forming the interlocked element. A slit means a simple slit through the material of the strip in its interlocking edge(s) where no material is cut away, whereas a cut means a cut in the material of the strip in its interlocking edge(s) where a part of the material is cut away. The slits or cuts should preferably extend from a border of the edge to the planar mid section. Such slits or cuts make it simpler to bend the interlocking edges to obtain the desired shape of the strip.

In an embodiment of the invention, the interlocking edges are interlocked with at least one interlocking element. The interlocking element is preferably a helically wound strip with a cross sectional profile comprising a U-section with a first and a second leg and a gap between the first and second legs. The first and/or the second leg optionally comprise one or more flanges protruding away from the gap.

In this embodiment the interlocking edges are arranged in the gap between the first and second legs. It should be observed that the interlocking element in an alternatively embodiment could be in the form of a plurality of clips with a cross sectional profile corresponding to the described helically wound strip with a cross sectional profile comprising a U-section.

In an embodiment of the invention, the first interlocking edge of a winding of the interlocked elongate element is interlocked to the second interlocking edge of an adjacent winding of the non-interlocked elongate element.

In an embodiment of the invention, the pressure armor comprises at least two helically wound elongate and interlocked elements, wherein one interlocking edge of a winding of a first of the interlocked elongate elements is interlocked to an adjacent interlocking edge of a winding of a second of the interlocked elongate elements.

In the embodiment comprising an interlocking element e.g. in the form of clips, the two edges of the interlocked elongate element can be identical e.g. each folded with a single fold, and thereby the interlocked elongate element can be folded very simply.

In an embodiment of the invention, the interlocking edges are interlocked without additional interlocking element(s).

In this embodiment the first interlocking edge of a winding of the interlocked elongate element is interlocked to the second interlocking edge of an adjacent winding of the interlocked elongate element, at least one of the first and the second interlocking edge is configured to have a groove into which the other one of the first and the second interlocking edge is arranged.

This folding may be more demanding than in the embodiment comprising interlocking element, however, if the strip to be folded is relatively thin, such as about 3 mm or less, this embodiment will normally be preferred because there will be less elements to handle.

In an embodiment of the invention, the pressure armor comprises at least two helically wound elongate and interlocked elements, where one interlocking edge of a winding of a first of the interlocked elongate elements is interlocked to an interlocking edge of an adjacent winding of a second of the interlocked elongate elements, wherein the interlocking edge of a winding of the first of the interlocked elongate elements is configured to have a groove into which the interlocking edge of the adjacent winding of the second of the interlocked elongate elements is arranged.

As mentioned above the interlocked elongate element is in an embodiment configured to have a groove. This may preferably be provided by folding of the interlocking edge. The folding may for example be provided by 3 approximately 90 degree folds. The skilled person will be able to select functional folds by the teaching applied herein and by using his ordinary skills.

For simplifying the production it is preferred that the interlocking edges each have an average thickness, determined perpendicular to their respective angle to the planar mid section wherein the average thickness is substantially equal to the thickness of the planar mid section. However, the skilled person will understand that these edge sections may be thicker or thinner than the midsection. Generally it is desired that the thickness of the interlocking edges is substantially uniform.

Unless other is specifically stated, the term “substantially” is used herein to include what is normally within ordinary production tolerances.

Generally it is desired that the non-interlocked elongate element is solid and has an average thickness determined in radial direction from the axis of the pipe which is larger, preferably at least about two times as large, such as at least about 3 times as large, such as at least about 4 times as large, such as at least about 5 times as large as the maximal thickness of the interlocked elongate element in the same radial direction from the axis of the pipe. If there are two or more layers of non-interlocked elongate elements, the thickness of the of the respective layers may be identical or it may differ from layer to layer. In an embodiment where there are two or more layers of non-interlocked elongate element, the total average thickness of the layered non-interlocked elongate elements determined in radial direction from the axis of the pipe is larger, preferably at least about two times as large, such as at least about 3 times as large, such as at least about 4 times as large, such as at least about 5 times as large the maximal thickness of the interlocked elongate element in the same radial direction from the axis of the pipe.

A solid element means herein that the element is not hollow or porous.

In an embodiment of the invention, the non-interlocked elongate element or the total average thickness of layered non-interlocked elongate elements has a cross-sectional profile and a maximal thickness in the cross-sectional profile determined in radial direction from the axis of the pipe, the maximal thickness of the non-interlocked elongate element is at least about 5 mm, such as at least about 6, such as at least about 7 mm, such as from about 5 mm to about 20 mm.

In an embodiment of the invention the thickness of the non-interlocked elongate element is substantially equal over its cross-sectional profile.

The thickness of the non-interlocked elongate element(s) is selected in order to provide a desired inertia while simultaneously taking into account the desired weight and material cost.

High inertia and high weight of the non-interlocked elongate element(s) can be obtained by selecting a large thickness and solid metal.

Low inertia and low weight of the non-interlocked elongate element(s) can be obtained by selecting a small thickness.

High inertia and low weight of the non-interlocked elongate element(s) can be obtained by selecting a large thickness and hollow metal tubes, or lighter material e.g. composite material.

Based on the above teaching the skilled person will be able to optimize inertia and weight of the pressure armor.

Advantageously the non-interlocked elongate element(s) are of solid material. It has been found that where the flexible unbounded pipe is subjected to dynamic movement, e.g. when used as riser it is desired that the non-interlocked elongate element(s) are not hollow, since such hollow non-interlocked elongate element(s) has shown to be too weak to widthstand such dynamic movements for longer time. In an embodiment the non-interlocked elongate element(s) are therefore of solid material e.g. comprising polymer, metal composit material or combinations thereof.

In an embodiment of the invention, the pressure armor comprises a plurality of non-interlocked elongate elements helically wound where the windings of one non-interlocked elongate element are arranged onto windings of another non-interlocked elongate element to provide layered windings of non-interlocked elongate elements: The layered windings of the non-interlocked elongate elements are held with a predetermined relative distance to each other by the interlocking edges of the helically wound interlocked elongate element(s). This embodiment provides that the non-interlocked elongate element in a simple way can be of thermoset polymer e.g. of fiber reinforced thermoset polymer material, such as pultruded elements. Elements of thermoset material may be difficult to wind without damaging the element, if the thickness exceeds a certain thickness dependent on the material. By applying thermoset elements in layers, the desired total thickness can be obtained. Another option is that the various layers of the non-interlocked elongate elements can be of different materials.

In an embodiment of the invention, the number of the non-interlocked elongate elements is equal to or larger than the number of interlocked elongate elements.

In an embodiment of the invention, the number of the non-interlocked elongate elements is 2 times, 3 times or 4 times the number of interlocked elongate elements.

In an embodiment of the invention the number of the non-interlocked elongate elements varies along the length of the unbonded flexible pipe. Thereby the inertia and/or the weight of the pressure armor can be varied as well. This gives a number of advantages as it will be clear from the following.

In an embodiment of the invention, the non-interlocked elongate element(s) has/have a substantially constant cross-sectional profile along at least a part of its length, preferably along all of its length. This makes the production very simple.

The non-interlocked elongate element(s) may in principle have any cross-sectional profile. However, for simplifying production and for good stability it is generally desired that the non-interlocked elongate element has at least a planar face facing towards and optionally in direct contact with the mid section of the interlocked elongate element it is placed above. Thereby a good support and distribution of forces against the inner sealing sheath is obtained and the risk of damaging the inner sealing sheath by the pressure armor is very low.

In the simplest embodiment the non-interlocked elongate element has a cross-sectional profile which is substantially rectangular. Such non-interlocked elongate element is both simple to produce and simple to apply.

In an embodiment of the invention, the non-interlocked elongate element(s) has/have a cross-sectional profile which is T-shaped or cleaved T-shape, along at least a part of its length, preferably along all of its length.

The term “a cleaved T-shape” means a T-shape which is obtained by cleaving through the vertical line of the T-shape to provide a left and a right cleaved T-shape which together provide a total T-shape. By using pairs (i.e. a left and a right cleaved T-shape) of cleaved T-shapes a higher flexibility of the pressure armor can be obtained without thereby reducing strength.

In an embodiment of the invention, the T-shape or cleaved T-shape has a bottom part (the lower most part of the T)) and a cross part (the cross line on top of the lower most part of the T), and the bottom part protrudes towards the planar mid section of the strip. In this embodiment the cross part may comprise at least one end face with a protrusion or a cavity, and the protrusion or the cavity of the non-interlocked elongate element is engaged with a protrusion or a cavity in an adjacent winding of the non-interlocked elongate element or with a protrusion or a cavity in an adjacent winding of another non-interlocked elongate element. Thereby a resistance against undesired radially displacements of the windings of the non-interlocked elongate element can be reduced or even avoided. The engagement between windings of non-interlocked elongate element does not hinder lengthwise displacements of the windings, such lengthwise displacements are hindered or reduced by the windings of the interlocking of the interlocked elongate element(s)

The planar mid section of the strip has a first surface facing towards and supporting the inner sealing sheath, the planar mid section has an average thickness determined in radial direction from the axis of the pipe, the non-interlocked elongate element has a cross-sectional profile and a maximal thickness in the cross-sectional profile determined in radial direction. In an embodiment of the invention the maximal thickness of the non-interlocked elongate element is larger than the average thickness of the planar section of the strip. Preferably the maximal thickness of the non-interlocked elongate element is at least about 1.5 times the average thickness of the planar section of the strip, such as at least about 2 times the average thickness of the planar section of the strip, such as at least about 3 times the average thickness of the planar section of the strip, such as at least about 4 times the average thickness of the planar section of the strip, such as at least about 5 times the average thickness of the planar section of the strip.

In an embodiment of the invention comprising layers of non-interlocked elongate elements, the planar mid section of the strip has a first surface facing towards and supporting the inner sealing sheath, the planar mid section has an average thickness determined in radial direction from the axis of the pipe, the layered windings of the non-interlocked elongate elements has a cross-sectional profile and a common maximal thickness in the cross-sectional profile determined in radial direction. The common maximal thickness of the layered windings of the non-interlocked elongate element is larger than the average thickness of the planar section of the strip. Preferably the maximal thickness of the layered windings of the non-interlocked elongate element is at least about 1.2 times the average thickness of the planar section of the strip, such as at least about 1.5 times the average thickness of the planar section of the strip, such as at least about 2 times the average thickness of the planar section of the strip, such as at least about 3 times the average thickness of the planar section of the strip, such as at least about 5 times the average thickness of the planar section of the strip.

In an embodiment of the invention, the planar mid section of the strip has a first surface facing towards and supporting the inner sealing sheath and a second surface opposite the first surface, wherein the non-interlocked elongate element(s) is/are arranged above and preferably in contact with the second surface, optionally with an intermediate film/foil layer and/or flanges protruding from interlocking element(s). Such intermediate film will in most situations be superfluous.

In an embodiment of the invention the non-interlocked elongate element(s) is/are wound onto the planar mid section of the strip such that it is placed between the first and the second interlocking bent edges in contact with the planar mid. This embodiment is relatively simple to produce and provides a good and safe support of the inner sealing sheath.

In an embodiment of the invention, adjacent windings of non-interlocked elongate elements are interlocked with an interconnecting element. In this embodiment the interconnecting element comprises one or more flanges placed on the mid section placed between the first and the second interlocking edges and the non-interlocked elongate element(s) is/are wound onto the planar mid section in contact with the one or more flanges of the interconnecting element, which is interconnecting edges of interlocked elongate element(s).

In an embodiment of the invention, the unbonded flexible pipe comprises an outer sealing sheath providing a sealing against ingress of sea water into the armoring layers when the pipe is submerged into sea water. Such outer sealing sheath is well known in the art and usually it also provides a mechanical protection of the unbonded flexible pipe.

In an alternative embodiment of the invention, no waterproof layer is arranged to surround the inner sealing sheath to thereby restrict hydrostatic pressure from acting on the inner sealing sheath. In use when the pipe is submerged into sea water the pressure armor and the tensile armor will be in contact with sea water and the materials of these armoring layers should therefore have a high corrosion resistance. Metal can be used in both of the above embodiments, depending on the type of metal and the corrosiveness of the sea water and the fluid to be transported.

The interlocked elongate element(s) is/are preferably of metal. In an embodiment of the invention, it is desired that the material of the interlocked elongate element(s) is relatively stiff such that it can be folded to the desired shape.

In an embodiment of the invention, at least one interlocked elongate element is of duplex-steel.

In an embodiment of the invention, at least one interlocked elongate element is of fiber reinforced polymer. This embodiment has a very high corrosion resistance and is particularly preferred in situation where the pressure armor will be in contact with sea water during use and/or in situations where the fluid to be transported has a high concentration of aggressive components that migrate through the inner sealing sheath during use of the unbonded flexible pipe.

In an embodiment of the invention, at least one interlocked elongate element is of cured pultruded composite material. The interlocked elongate element of cured pultruded composite material is shaped to a strip with a cross-sectional profile comprising a planar mid section and a first and a second interlocking edge with an angle to the planar mid section protruding in a direction away from the inner sealing sheath to provide a channel prior to final curing thereof.

Pultruded composite elements are well known in the art, e.g. as described in U.S. Pat. No. 6,872,343, U.S. Pat. No. 6,106,944 or DK PA 20101108.

In an embodiment of the invention, the non-interlocked elongate element(s) is/are of an optionally reinforced polymer material.

In an embodiment of the invention, the non-interlocked elongate element(s) comprise(s) polymer, such as elastomer and/or thermoplast, the non-interlocked elongate element(s) is/are optionally of polymer reinforced e.g. with fibers and/or particles.

In an embodiment of the invention, the non-interlocked elongate element(s) is/are a pultruded fiber reinforced polymer element.

In an embodiment of the invention, the pressure armor of the unbonded flexible pipe comprises two or more non-interlocked elongate elements placed upon each other, optionally in the form of a first elastomer non-interlocked elongate element and a second elastomer non-interlocked elongate element and intermediate arranged continuous fibers, such as polypropylene fibers, carbon fibers, glass fibers, aramid fibers, basalt fibers, steel fibers, polyethylene fibers, mineral fibers and/or mixtures and/or combinations comprising at least one of the foregoing fibers.

The continuous fibers may for example be in the form of filaments, strands, yarns, rovings, fiber bundles or combinations thereof. The fibers may in one embodiment comprise a fiber bundle comprising spun, knitted, woven, braided fibers and/or are in the form of a regular or irregular network of fibers and/or a fiber bundle cut from one or more of the foregoing.

Filaments are continuous single fiber (also called monofilament).

The phrase “continuous” as used herein in connection with fibers, filaments, strands, or rovings means that the fibers, filaments, strands, yarns, or rovings in generally have a significant length but should not be understood to mean that the length is perpetual or infinite. Continuous fibers, such as continuous filaments, strands, yarns, or rovings preferably have length of at least about 10 m, preferably at least about 100 m, more preferably at least about 1000 m.

The term “strand” is used to designate an untwisted bundle of filaments.

The term “yarn” is used to designate a twisted bundle of filaments and/or cut fibers. Yarn includes threads and ropes. The yarn may be a primary yarn made directly from filaments and/or cut fibers, or a secondary yarn made from yarns and/or cords. Secondary yarns are also referred to as cords.

The term “roving” is used to designate an untwisted bundle of strands or yarns. A roving includes a strand of more than two filaments. A non twisted bundle of more than two filaments is accordingly both a strand and a roving.

In an embodiment where no waterproof layer is arranged to surround the inner sealing sheath it is desired that the armor layers are of polymer, fiber reinforced polymer and/or duplex steel.

In order to ensure a desired flexibility of the unbonded flexible pipe while simultaneously having a high strength it is desired that the pressure armor of the unbonded flexible pipe has windings of the non-interlocked elongate element(s) which are held with a predetermined relative distance which can vary between a predetermined maximum distance Dₘₐₓ and a predetermined minimum distance Dₘᵢₙ to each other by the interlocking edges of the helically wound interlocked elongate element(s), preferably 1.1*Dₘᵢₙ≦Dₘₐₓ≦2*Dₘᵢₙ. An interval between Dₘₐₓ and Dₘᵢₙ is normally referred to as a play.

For a good flexibility and high inertia the Dₘₐₓ may be selected in relation to the maximal width of the non-interlocked elongate element. In an embodiment of the invention, the non-interlocked elongate element(s) has/have a cross-sectional profile with a thickness determined in radial direction and a maximal width determined perpendicular to the radial direction, wherein the maximal width Wₘₐₓ is larger than the predetermined maximum distance Dₘₐₓ between windings of the non-interlocked elongate element.

In a preferred embodiment 1.1*Dₘₐₓ≦Wₘₐₓ≦5*Dₘₐₓ.

In a preferred embodiment 1.5*Dₘₐₓ≦Wₜₒₚ≦3*Dₘₐₓ.

In an embodiment of the invention, the non-interlocked elongate element(s) has/have a cross-sectional profile with a thickness determined in radial direction and a top width determined perpendicular to the radial direction at a surface of the non-interlocked elongate element facing away from the inner sealing sheath (in other words, the width of the non-interlocked elongate element where it is facing away from the inner sealing sheath), wherein the maximal width Wₜₒₚ is larger than the predetermined maximum distance Dₜₒₚ between windings of the non-interlocked elongate element.

In this embodiment a winding of the non-interlocked elongate element extends beyond at least one of the edges of the interlocked elongate element it is placed above in a direction perpendicular to the winding direction of the non-interlocked elongate element.

In an embodiment of the invention, in order to provide a simple and cost effective production the non-interlocked elongate element(s) has/have a cross-sectional profile with a thickness determined in radial direction and width determined perpendicular to the radial direction, wherein the width is substantially constant along the length of the non-interlocked elongate element.

Due to the present invention the unbonded flexible pipe comprises in an embodiment two or more sections with different properties due to at least one difference of the pressure armor. This embodiment is in particular useful for unbonded flexible pipes for deep water applications, e.g. where high weight is required in one or more length sections, but low weight is desired in another or other section(s).

In an embodiment of the invention, the unbonded flexible pipe has two or more length sections, wherein the pressure armor differs from one length section to another length section in that at least one property, the thickness, the cross-sectional shape(s) and/or the number of non-interlocked elongate elements is different.

In an embodiment of the invention, the at least one helically wound elongate and interlocked element is identical in the two or more sections of the unbonded flexible pipe and at least one helically wound elongate and non-interlocked elongate element is of a different material or material combination from one section to another. The at least one helically wound elongate and non-interlocked elongate element preferably has one or more sampling points where one non-interlocked elongate element section of a first material or material combination is connected to another non-interlocked elongate element section of a first material or material combination.

The sampling point(s) may be provided by any means depending on the type of material of the non-interlocked elongate element(s), the shape and the structure of the non-interlocked elongate elements.

In an embodiment of the invention, the connection(s) is/are performed using a connecting fitting, glue, nail(s), snap lock(s) or combinations thereof. The connection may be mechanical, chemical, or a combination thereof.

In an embodiment of the invention, the connection(s) is/are performed using epoxy e.g. in combination with a connecting fitting.

In an embodiment of the invention, the unbonded flexible pipe comprises along its length a bottom section adapted to be closer to a sea bottom and a top section adapted to be closer to a sea surface, the pressure armor in the bottom section is heavier per length unit than the pressure armor of the top section.

In an embodiment of the invention, the unbonded flexible pipe comprises one or more mid sections between the bottom section and the top section, the relative weight (weight per length unit) of the pressure armor increases from section to section from the top section to the bottom section.

### DRAWINGS AND EXAMPLES

The invention will be explained more fully below in connection with some embodiments and with reference to the drawings in which:

FIG. 1 shows a schematic side view of a flexible unbonded pipe of the invention comprising a pressure armor of interlocked and non-interlocked elements as described above.

FIG. 2 shows a schematic side view of a second embodiment of a flexible unbonded pipe of the invention.

FIG. 3 shows a schematic cross-sectional view of a pressure armor of a flexible unbonded pipe of the invention where the view is in a cross section of the interlocked and non-interlocked wound elements where the interlocking edges of the interlocked element(s) are interlocked with an interlocking element or a plurality of interlocking elements.

FIG. 4 shows a schematic cross-sectional view of a pressure armor of a flexible unbonded pipe of the invention corresponding to the unbonded flexible pipe of FIG. 3, where the distance D between windings of the non-interlocked elongate element and the width W is indicated.

FIG. 5 shows a schematic cross-sectional view of a pressure armor of a another flexible unbonded pipe of the invention where the view is in a cross section of the interlocked and non-interlocked wound elements where the interlocking edges of the interlocked element(s) are interlocked with an interlocking element or a plurality of interlocking elements.

FIG. 6 shows a schematic cross-sectional view of a pressure armor of a flexible unbonded pipe of the invention where the view is in a cross section of the interlocked and non-interlocked wound elements where the interlocking edges of the interlocked element(s) are interlocked without additional interlocking element(s).

FIG. 7 shows a schematic cross-sectional view of a pressure armor of another flexible unbonded pipe of the invention where the view is in a cross section of the interlocked and non-interlocked wound elements where the interlocking edges of the interlocked element(s) are interlocked without additional interlocking element(s).

FIG. 8 shows a schematic cross-sectional view of a pressure armor of another flexible unbonded pipe of the invention where the view is in a cross section of the interlocked and non-interlocked wound elements where the interlocking edges of the interlocked element(s) are interlocked without additional interlocking element(s) and wherein the non-interlocked elongate element has a T-shaped cross-section.

FIG. 9 shows a schematic cross-sectional view of a pressure armor of another flexible unbonded pipe of the invention where the view is in a cross section of the interlocked and non-interlocked wound elements where the interlocking edges of the interlocked element(s) are interlocked are interlocked with an interlocking element or a plurality of interlocking elements, and wherein the non-interlocked elongate elements have a cleaved T-shaped cross-section and wherein adjacent windings of non-interlocked elongate cleaved T-shaped element are engaged.

FIG. 10 shows a schematic cross-sectional view of a pressure armor of another flexible unbonded pipe of the invention where the view is in a cross section of the interlocked and non-interlocked wound elements where the interlocking edges of the interlocked element(s) are interlocked with an interlocking element or a plurality of interlocking elements, and wherein the non-interlocked elongate elements have a T-shaped cross-section and wherein adjacent windings of non-interlocked elongate element are engaged.

FIG. 11 is a top view of a strip for an interlocked elongate element with slits and cuts extending from a border of the edge towards the planar mid section of the strip forming the interlocked element.

FIG. 12 shows an offshore system comprising an unbonded flexible pipe of the invention in the form of a riser where the pipe comprises different pressure armor structures in different sections of the unbonded flexible pipe.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

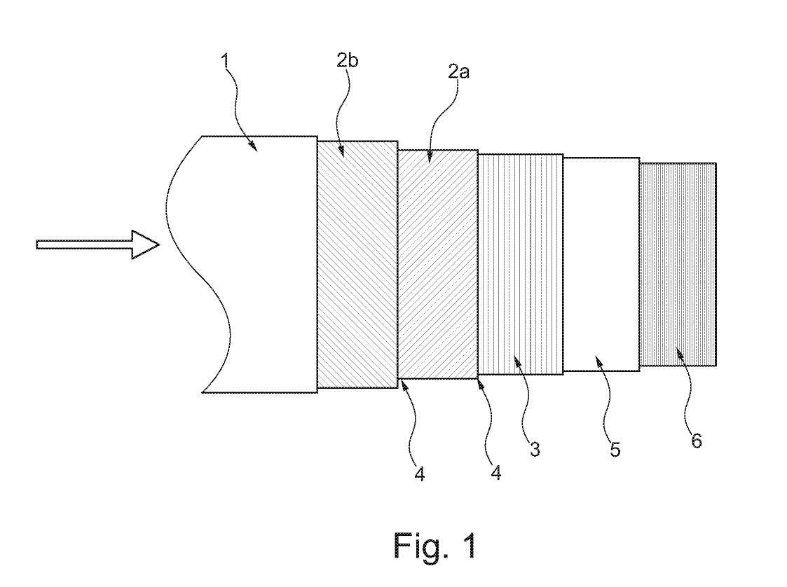

FIG. 1 shows a schematic side view of a flexible unbonded pipe of the invention.

The flexible unbonded pipe comprises from inside out a carcass 6, an internal sealing sheath 5, a pressure armor layer 3 of not shown interlocked and non-interlocked elements as described above, a first tensile armor layer 2a, a second tensile armor layer 2b and an outer sealing sheath 1 (an outer protecting sheath).

Between the pressure armor layer 3 and the first tensile armor layer 2a as well as between the first tensile armor layer 2a and the second tensile armor layer 2b anti-wear layers indicated with reference number 4 may be arranged to protect the respective layers from wear.

The carcass 6 may for example be of one or more helically wound reinforcement elements, wound with an angle to the center axis of 80 degrees or more, such as it is generally known in the art, or it may for example be of more or of annular reinforcement rings optionally held together by connecting elements.

The internal sealing sheath 5 may be a single layer structure or a multi-layer.

In one embodiment the internal sealing sheath comprises cross linked polyethylene (PEX), polyimide (PA-11, PA 12) PVDF and/or other flour containing polymers.

The pressure armor comprises at least one not shown helically wound elongate and interlocked element and at least one helically wound elongate and non-interlocked elongate element, where the helically wound element(s) for example is wound with an angle to the axis of the pipe which is from about 75 degrees to as close to 90 degrees as possible, such as with an angle to the axis of the pipe which is from about 80 degrees to about 85 degrees. The pressure armor 3 may comprise one or more layers.

The innermost layer 2a of the cross wound armoring layers 2a, 2b is here referred to as the first tensile armoring layer 2a and comprises first helically wound, elongate armoring elements wound in a first winding direction e.g. with an angle of about 55 degrees or less, such as about 45 to about 30 degrees relative to the center axis. The outermost layer 2b of the cross wound armoring layers 2a,2b is here referred to as the second tensile armoring layer 2b and comprises second helically wound, elongate armoring elements wound in a second winding direction e.g. with an angle of about 55 degrees or less, such as about 45 to about 30 degrees relative to the center axis.

The first helically wound, elongate armoring elements and the second helically wound, elongate armoring elements are cross wound with respect to each other, and the winding angles with respect to the center axis may be of equal size or they may differ from each other. In order to balance the load from a pulling in the unbonded flexible pipe between the tensile armoring layers 2a, 2b, the winding angle of the first helically wound, elongate armoring elements may for example be different from the winding angle of the second helically wound, elongate armoring elements.

The outermost sealing sheath 1 has the function of preventing ingress of sea water when the unbonded flexible pipe is submerged into sea water such as it is known in the art.

The flexible pipe may have fewer or more layers than the pipe shown in FIG. 1, for example the pipe may have additional layers such as an insulation layer, additional protection layers, intermediate layers and other, and the pressure armor and/or the outer sealing sheath may e.g. be omitted.

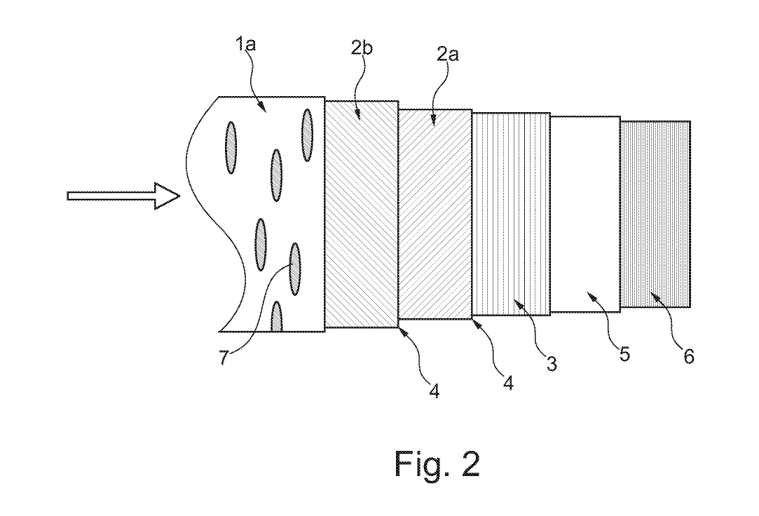

FIG. 2 shows a variation of the pipe of FIG. 1 wherein the outer sealing sheath is perforated with openings 7 such that it still provides mechanical protection of the unbonded flexible pipe, but such that no waterproof layer is arranged to surround the inner sealing sheath to thereby restrict hydrostatic pressure from acting on the inner sealing sheath. In use when the pipe is submerged into sea water, the pressure armor and the tensile armor will be in contact with sea water and the materials of these armoring layers should therefore have a high corrosion resistance.

The respective layers of the unbonded flexible pipe of FIG. 1 and FIG. 2 may be of materials as described above and in the claims.

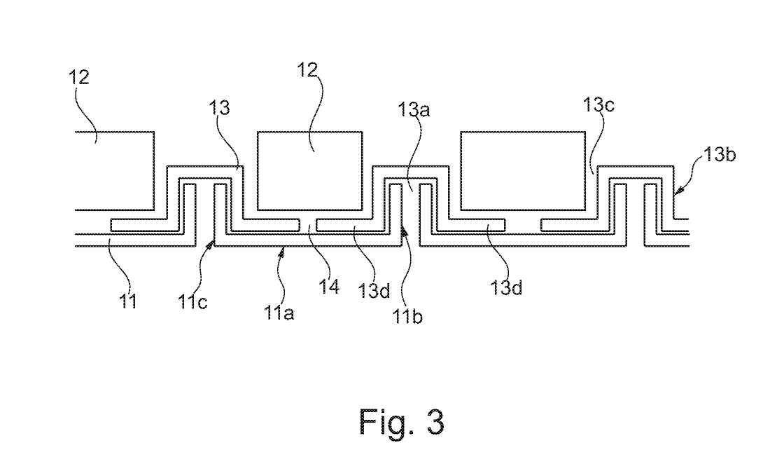

FIG. 3 shows a pressure armor of a flexible unbonded pipe of the invention comprising interlocked wound element 11 and non-interlocked wound element 12 where the interlocking edges of adjacent windings of the interlocked element are interlocked with an interlocking element 13 or a plurality of interlocking elements 13. In FIG. 3 it cannot be seen if the adjacent windings of the interlocked element are interlocked with an interlocking element 13 or with a plurality of interlocking elements 13, where such plurality of interlocking elements 13 in principle are merely clips which could be provided by sectioning an elongate element with the desired interlocking profile.

The helically wound elongate and interlocked element 11 is in the form of a strip with a cross-sectional profile comprising a planar mid section 11a and a first and a second interlocking edge 11b, 11c configured to have an angle to the planar mid section 11a and to protrude in a direction away from the inner sealing sheath to provide a channel 14 between the first and the second interlocking edges 11b, 11c. The windings of the helically wound elongate and non-interlocked elongate element 12 are placed at least partly in the channel 14 such that displacement with respect to the helically wound elongate and interlocked element is limited by the first and the second interlocking edges 11b, 11c.

The interlocking edges 11b, 11c have angles to the mid section 11a which are approximately perpendicular.

The interlocking element 13 has a cross sectional profile comprising a U-section with a first and a second leg 13b, 13c and a gap 13a between the first and second legs 13b, 13c, the first and the second leg 13b, 13c comprise each a flange 13d protruding away from the gap 13a.

The interlocking edges 11b, 11c are arranged in the gap 13a between the first and second legs 13b, 13c.

The non-interlocked elongate element 12 has a rectangular cross section.

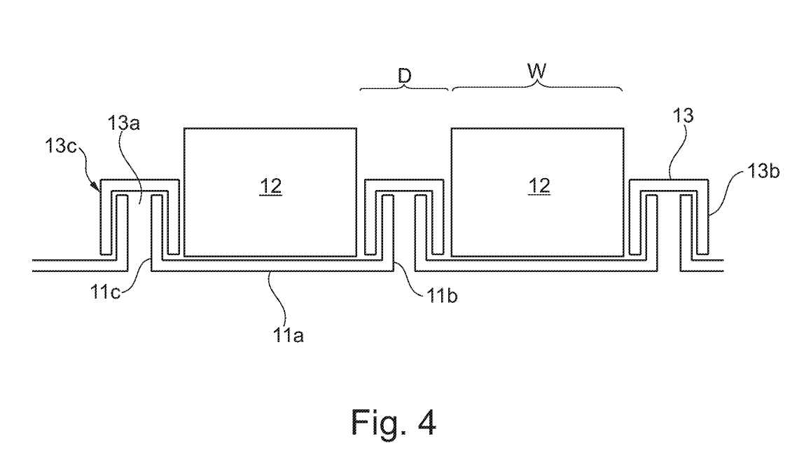

The pressure armor shown in FIG. 4 differs from the pressure armor of FIG. 3 in that the interlocking element 13 has a cross sectional profile comprising a U-section with a first and a second leg 13b, 13c and a gap 13a between the first and second legs 13b, 13c, but the interlocking element 13 does not comprise flanges 13d as in the pressure armor of FIG. 3. In FIG. 4 the distance D between windings of the non-interlocked elongate element and the width W is indicated.

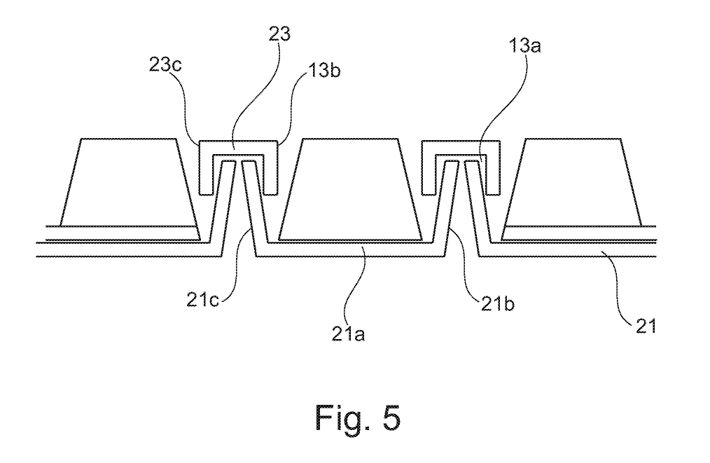

The pressure armor shown in FIG. 5 comprises interlocked wound element 21 and non-interlocked wound element 22 where the interlocking edges of adjacent windings of the interlocked element are interlocked with an interlocking element 23 or a plurality of interlocking elements 23.

The helically wound elongate and interlocked element 21 is in the form of a strip with a cross-sectional profile comprising a planar mid section 21a and a first and a second interlocking edge 21b, 21c configured to have an angle to the planar mid section 21a and to protrude in a direction away from the inner sealing sheath to provide a channel between the first and the second interlocking edges 21b, 21c. The windings of the helically wound elongate and non-interlocked elongate element 22 are placed at least partly in the channel such that displacement with respect to the helically wound elongate and interlocked element is limited by the first and the second interlocking edges 21b, 21c.

The interlocking edges 21b, 21c have angles to the mid section 11a which are about 100 degrees.

The interlocking element 23 has a cross sectional profile comprising a U-section with a first and a second leg 23b, 23c and a gap 23a between the first and second legs 23b, 23c.

The interlocking edges 21b, 21c are arranged in the gap 23a between the first and second legs 23b, 23c.

The non-interlocked elongate element 12 has a trapezoid cross section.

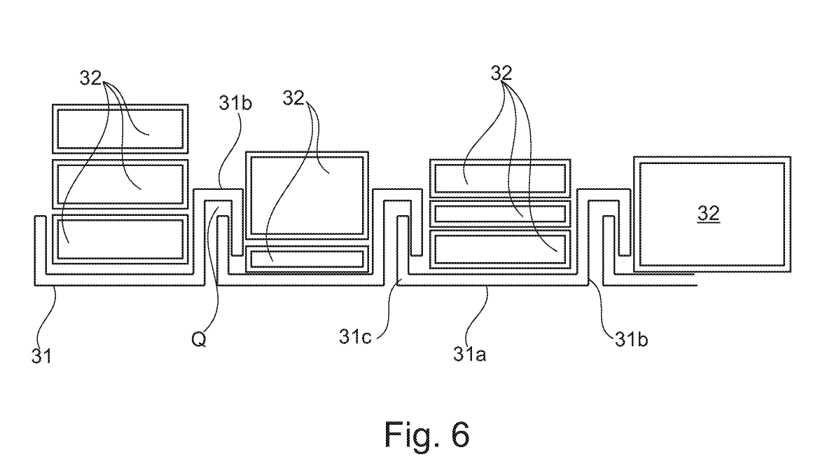

The pressure armor shown in FIG. 6 comprises interlocked wound element 31 and non-interlocked wound elements 32 where the interlocking is provided without additional interlocking element(s).

The helically wound elongate and interlocked element 31 is in the form of a strip with a cross-sectional profile comprising a planar mid section 31a and a first and a second interlocking edge 31b, 31c configured to have an angle to the planar mid section 31a and to protrude in a direction away from the inner sealing sheath to provide a channel between the first and the second interlocking edges 31b, 31c. The windings of the helically wound elongate and non-interlocked elongate elements 32 are placed at least partly in the channel such that displacement with respect to the helically wound elongate and interlocked element is limited by the first and the second interlocking edges 31b, 31c.

Windings of non-interlocked elongate elements 32 with rectangular shape are arranged on top of each other as indicated with the layered structure. The windings of non-interlocked elongate elements 32 may be different from each other or equal in thickness and/or in material.

The first interlocking edge 31b of a winding of the interlocked elongate element is interlocked to the second interlocking edge 31c of an adjacent winding of the interlocked elongate element 31 or of another interlocked elongate element. The first interlocking edge 31b is configured to have a groove Q into which the second interlocking edge 31c of an adjacent winding is arranged.

The interlocked elongate element is configured to have the groove Q by folding of the first interlocking edge 31b.

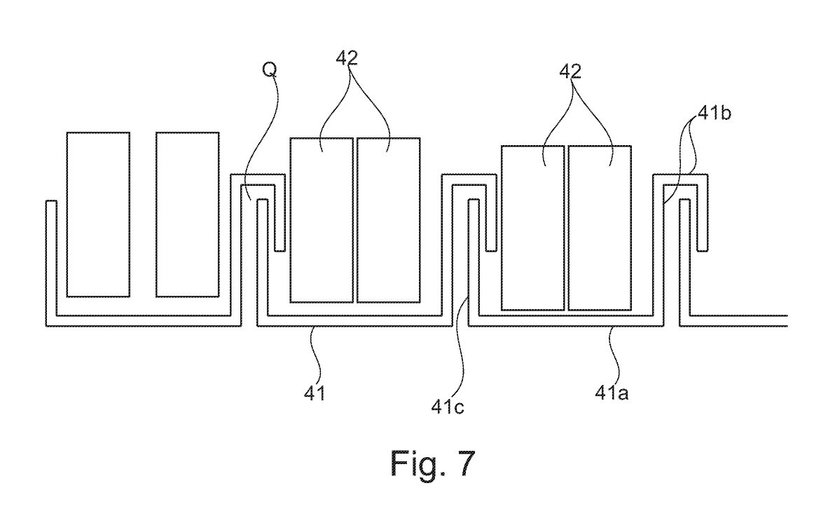

The pressure armor shown in FIG. 7 comprises interlocked wound element 41 and non-interlocked wound elements 42 where the interlocking is provided without additional interlocking element(s). As it can be seen the number of non-interlocked wound elements 42 is two times the number of interlocked wound element 41.

The helically wound elongate and interlocked element 41 is in the form of a strip with a cross-sectional profile comprising a planar mid section 41a and a first and a second interlocking edge 41b, 41c configured to have an angle to the planar mid section 41a and to protrude in a direction away from the inner sealing sheath to provide a channel 44 between the first and the second interlocking edges 41b, 41c. As it can be seen, the thickness of the planar mid section 41a is larger e.g. two times larger than the thickness of the first and the second interlocking edges 41b, 41c. The windings of the helically wound elongate and non-interlocked elongate elements 42 are placed at least partly in the channel such that displacement with respect to the helically wound elongate and interlocked element is limited by the first and the second interlocking edges 41b, 41c. As it can be seen in this embodiment windings of non-interlocked wound element 42 are arranged in each channel 44.

Windings of non-interlocked elongate elements 42 with rectangular shape are arranged side by side in the channels 14. The windings of non-interlocked elongate elements 42 may be different from each other or equal in thickness and/or in material.

The first interlocking edge 41b of a winding of the interlocked elongate element is interlocked to the second interlocking edge 41c of an adjacent winding of the interlocked elongate element 41, or of another interlocked element. The first interlocking edge 41b is configured to have a groove Q into which the second interlocking edge 41c of an adjacent winding is arranged.

The interlocked elongate element is configured to have the groove Q by folding of the first interlocking edge 41b.

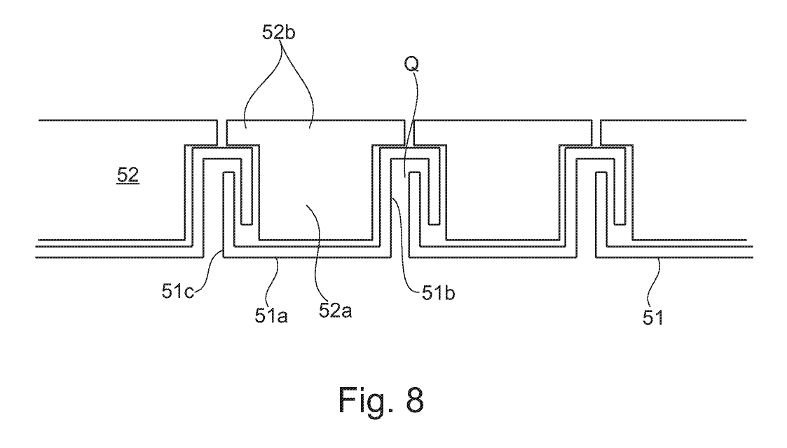

The pressure armor shown in FIG. 8 comprises interlocked wound element 51 and non-interlocked wound element 52 where the interlocking is provided without additional interlocking element(s). The non-interlocked elongate element 52 has a T-shaped cross-section, thereby provides that the distance between adjacent windings of non-interlocked wound element 52 has a play from no distance to a very small distance.

The T-shape of the non-interlocked elongate element 52 has a bottom part 52a (the lower most part of the T) and a cross part 52b (the cross line on top of the lower most part of the T), the bottom part 52a protrudes towards the planar mid section 51a of the strip.

The helically wound elongate and interlocked element 51 is in the form of a strip with a cross-sectional profile comprising a planar mid section 51a and a first and a second interlocking edge 51b, 51c configured to have an angle to the planar mid section 51a and to protrude in a direction away from the inner sealing sheath to provide a channel between the first and the second interlocking edges 51b, 51c. The windings of the helically wound elongate and non-interlocked elongate elements 52 are placed at least partly in the channel such that displacement with respect to the helically wound elongate and interlocked element is limited by the first and the second interlocking edges 51b, 51c.

The first interlocking edge 51b of a winding of the interlocked elongate element is interlocked to the second interlocking edge 51c of an adjacent winding of the interlocked elongate element 51, or of another interlocked element. The first interlocking edge 51b is configured to have a groove Q into which the second interlocking edge 51c of an adjacent winding is arranged.

The interlocked elongate element is configured to have the groove Q by folding of the first interlocking edge 51b.

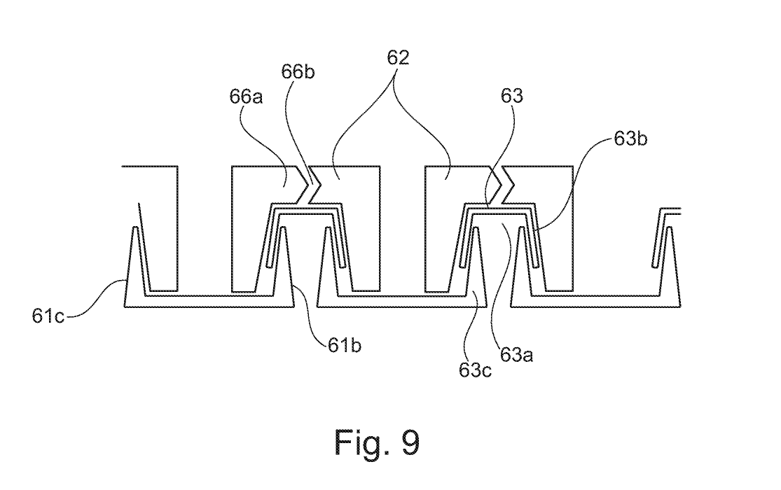

The pressure armor shown in FIG. 9 comprises interlocked wound element 61 and non-interlocked wound elements 62 where the interlocking edges of the interlocked element(s) are interlocked with an interlocking element 63 or a plurality of interlocking elements 63. The non-interlocked elongate elements 62 have cleaved T-shaped cross-section and adjacent windings of non-interlocked elongate cleaved T-shaped element are engaged, but not interlocked.

The helically wound elongate and interlocked element 61 is in the form of a strip with a cross-sectional profile comprising a planar mid section 61a and a first and a second interlocking edge 61b, 61c configured to have an angle to the planar mid section 61a and to protrude in a direction away from the inner sealing sheath to provide a channel between the first and the second interlocking edges 61b, 61c. The windings of the helically wound elongate and non-interlocked elongate elements 62 are placed at least partly in the channel such that displacement with respect to the helically wound elongate and interlocked element is limited by the first and the second interlocking edges 61b, 61c.

The first and the second interlocking edges 61b, 61c have triangular cross-section.

Adjacent windings of non-interlocked elongate elements 62 with cleaved T-shape are engaged, but not interlocked.

The cleaved T-shape of the non-interlocked elongate elements 52 has bottom parts 62a (the lower most parts of the cleaved T) and cross parts 62b (the cross line on top of the lower most parts of the cleaved T), the bottom parts 62a protrude towards the planar mid section 61a, the cross parts 62b comprise a first end face with a protrusion 66a and a second face part with a corresponding cavity 66b. The protrusion 66a of a winding of a non-interlocked elongate element 62 is engaged with a cavity 66b of an adjacent winding of a non-interlocked elongate element 62.

Windings of non-interlocked elongate elements 62 with cleaved T-shaped cross-section are arranged such that they may be displaced with respect to each other (i.e. the respective distances between windings of the non-interlocked wound elements 62 have a play), such that the respective windings of the non-interlocked wound elements 62 in some positions are engaged and in some positions are not engaged with adjacent windings.

The first interlocking edge 61b of a winding of the interlocked elongate element is interlocked to the second interlocking edge 61c of an adjacent winding of the interlocked elongate element 61, or of another interlocked element by interlocking element (s) 63.

The interlocking element 63 has a cross sectional profile comprising a U-section with a first and a second leg 63b, 63c and a gap 63a between the first and second legs 63b, 63c. The first and the second interlocking edges 61b, 61c of an adjacent winding are arranged in the gap 63a.

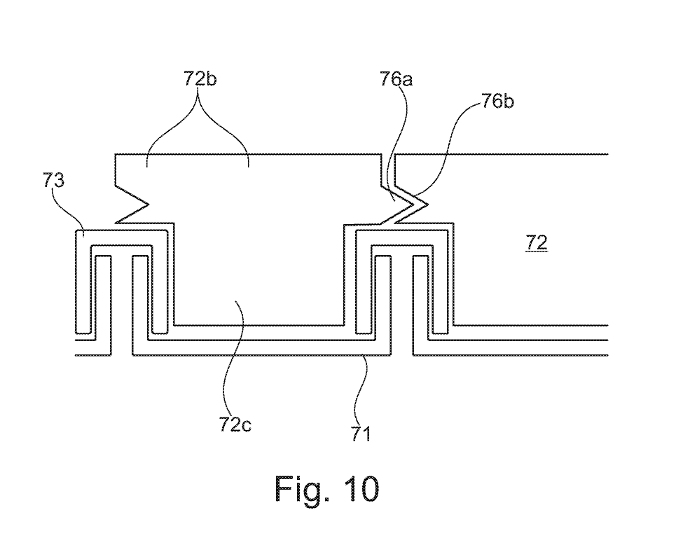

The pressure armor shown in FIG. 10 comprises interlocked wound element 71 and non-interlocked wound element 72 where the interlocking edges of the interlocked element(s) are interlocked with an interlocking element 73 or a plurality of interlocking elements 73.

The non-interlocked elongate element 72 has a T-shaped cross-section.

The T-shape of the non-interlocked elongate elements 72 has bottom part 72a and a cross part 72b, the bottom part 72a protrudes towards the planar mid section, the cross part 72b comprises a first end face with a protrusion 76a and a second face part with a corresponding cavity 76b. The protrusion 76a of a winding of a non-interlocked elongate element 72 is engaged with a cavity 76b of an adjacent winding of a non-interlocked elongate element 72.

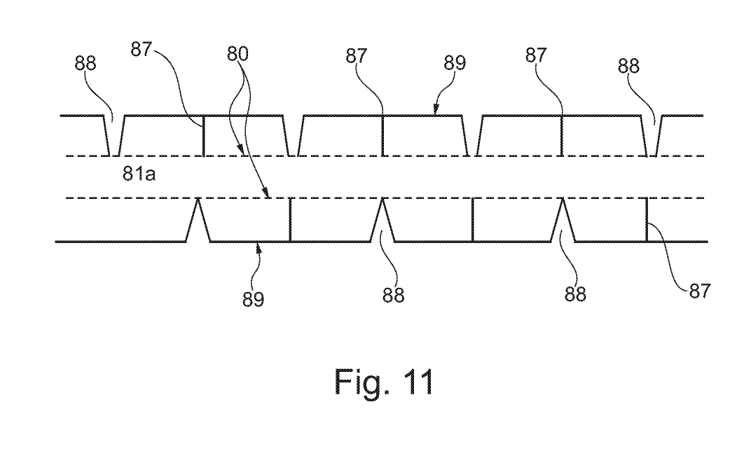

FIG. 11 is a top view of a strip which is configured for an interlocked elongate element. The strip has a planar mid section 11a and a first and a second edge 81b, 81c which can be folded along folding line 80 to have an angle to the planar mid section 81a. Edges 81b, 81 c each have a border 89. The strip is provided with slits 87 and cuts 88 extending from a border 89 of the first or the second edges 81b, 81c towards the planar mid section 81a of the strip.

The cuts 88 may in principle have any shape, but it is generally desired that no more than about 50% of the edges are removed by cuts.

It should be noted that a strip without such slits and/or cuts could also be used, but if the strip is relatively thick it may be simpler to use a strip with slits and/or cuts, and additional cuts may provide the strip to be lighter.

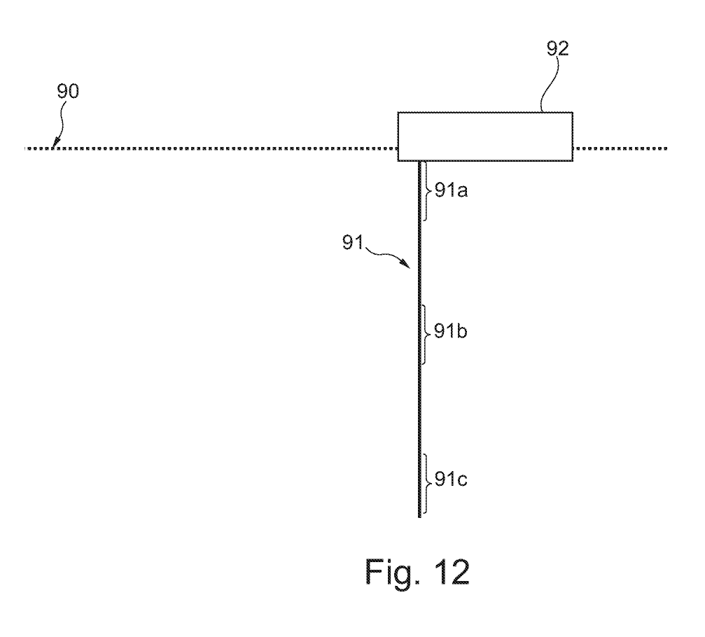

FIG. 12 shows an offshore system comprising an unbonded flexible pipe of the invention in the form of a riser where the pipe comprises different pressure armor structures in different sections of the unbonded flexible pipe.

The offshore system comprises a pipe 91 of the invention. The dotted line 90 indicates the sea surface. The offshore system further comprises a sea surface installation 92, such as a ship or a platform. The flexible pipe 91 is a riser arranged to transport liquid between the sea surface installation 92 and a not shown installation at a certain depth of water, e.g. near the seabed (not shown). The flexible pipe 91 is for example a pipe as shown in FIG. 1 or FIG. 2 as described above where the unbonded flexible pipe 92 has three length sections 91a, 91b, 91c, wherein the pressure armor differs from each other in that at least one property, the thickness, the cross-sectional shape(s) and/or the number of non-interlocked elongate elements differs from one section of the unbonded flexible pipe 91 to another section of the unbonded flexible pipe 91.

The unbonded flexible pipe 91 comprises along its length a bottom section 91c adapted to be closer to a sea bottom, a top section 91a adapted to be closer to a sea surface and a mid section 91b. The pressure armor in the bottom section 91c is heavier per length unit than the pressure armor of the top section 91 a, and the pressure armor of the mid section 91b may have a weight per length unit between the weight per length unit of the top section 91a and the bottom section 91c.

Some preferred embodiments have been shown in the foregoing, but it should be stressed that the invention is not limited to these, but may be embodied in other ways within the subject-matter defined in the following claims.

What is claimed is:

1-49. (canceled)

50. An unbonded flexible pipe for subsea transportation of fluids, the pipe has a length and comprises a carcass surrounded by an inner sealing sheath defining a bore in which fluids can be transported and an axis of the pipe, on the outer side of the inner sealing sheath the pipe comprises a pressure armor comprising at least one helically wound elongate element wound with an angle to the axis of about 70 degrees or higher, on the outer side of the pressure armor the pipe comprises a tensile armor comprising a first and a second layer each comprising a plurality of helically wound elongate elements wound with an angle to the axis of about 65 degrees or less, where the first layer of the tensile armor is cross-wound with respect to the second layer of the tensile armor, and
wherein the pressure armor comprises at least one helically wound elongate and interlocked element in the form of a strip with a cross-sectional profile comprising a planar mid section and a first and a second interlocking edge configured to have an angle to the planar mid section and to protrude in a direction away from the inner sealing sheath to provide a channel between the first and the second interlocking edges, the pressure armor further comprises at least one helically wound elongate and non-interlocked elongate element where windings of the non-interlocked elongate element are placed at least partly in the channel such that displacement with respect to the helically wound elongate and interlocked element is limited by the first and the second interlocking edges.

51. The unbonded flexible pipe as claimed in claim 50, wherein the non-interlocked elongate element is a solid element.

52. The unbonded flexible pipe as claimed in claim 50, wherein windings of the non-interlocked elongate element are held with a predetermined relative distance to each other by the interlocking edges of the helically wound interlocked elongate element(s).

53. The unbonded flexible pipe as claimed in claim 50, wherein no waterproof layer is arranged to surround the inner sealing sheath to thereby restrict hydrostatic pressure from acting on the inner sealing sheath.

54. The unbonded flexible pipe as claimed in claim 50, wherein the non-interlocked elongate element(s) is/are of an optionally reinforced polymer material.

55. The unbonded flexible pipe as claimed in claim 50 wherein the strip in its planar mid section has a substantially identical cross-sectional profile along at least a part of its length.

56. The unbonded flexible pipe as claimed in claim 50, wherein the strip in its planar mid section has a substantially identical cross-sectional profile along all of its length.

57. The unbonded flexible pipe as claimed in claim 50, wherein the planar mid section of the strip has a first surface facing towards and supporting the inner sealing sheath, the planar mid section has an average thickness determined in radial direction from the axis of the pipe and a width determined over its cross section and perpendicular to its thickness.

58. The unbonded flexible pipe as claimed in claim 57, wherein the thickness of the plane section is substantially constant over its width.

59. The unbonded flexible pipe as claimed in claim 50, wherein the planar mid section of the strip has a first surface facing towards and supporting the inner sealing sheath, the planar mid section has an average thickness determined in radial direction from the axis of the pipe, the average thickness is about 5 mm or less.

60. The unbonded flexible pipe as claimed in claim 59, wherein the average thickness is from about 0.2 to about 5 mm.

61. The unbonded flexible pipe as claimed in claim 50, wherein the interlocking edges are configured to have an angle to the planar mid section by being folded.

62. The unbonded flexible pipe as claimed in claim 50, wherein the interlocking edges have angles to the planar mid section of from about 70 degrees to about 110 degrees,

63. The unbonded flexible pipe as claimed in claim 50, wherein the interlocking edges have angles to the planar mid section of from about 80 degrees to about 100 degrees.

64. The unbonded flexible pipe as claimed in claim 50, wherein the interlocking edges have angles to the planar mid section of from about 85 degrees to about 95 degrees.

65. The unbonded flexible pipe as claimed in claim 50, wherein at least one of the first and the second interlocking edges of the strip comprises slits or cuts extending from a border of the edge towards the planar mid section of the strip forming the interlocked element.

66. The unbonded flexible pipe as claimed in claim 50, wherein the interlocking edges are interlocked to at least one interlocking element, the interlocking element is a helically wound strip with a cross sectional profile comprising a U-section with a first and a second leg and a gap between the first and second legs,

67. The unbonded flexible pipe as claimed in claim 66, wherein the first leg comprises one or more flanges protruding away from the gap.

68. The unbonded flexible pipe as claimed in claim 66, wherein the second leg comprises one or more flanges protruding away from the gap.

69. The unbonded flexible pipe as claimed in claim 66, wherein the interlocking edges are arranged in the gap between the first and second legs.

70. The unbonded flexible pipe as claimed in claim 50, wherein the first interlocking edge of a winding of the interlocked elongate element is interlocked to the second interlocking edge of an adjacent winding of the non-interlocked elongate element.

71. The unbonded flexible pipe as claimed in claim 50, wherein the pressure armor comprises at least two helically wound elongate and interlocked elements, wherein one interlocking edge of a winding of a first of the interlocked elongate elements is interlocked to an adjacent interlocking edge of a winding of a second of the interlocked elongate elements.

72. The unbonded flexible pipe as claimed in claims 50, wherein the interlocking edges are interlocked without additional interlocking element(s).

73. The unbonded flexible pipe as claimed in claim 50, wherein the first interlocking edge of a winding of the interlocked elongate element is interlocked to the second interlocking edge of an adjacent winding of the interlocked elongate element, at least one of the first and the second interlocking edges is configured to have a groove into which the other one of the first and the second interlocking edges is arranged.

74. The unbonded flexible pipe as claimed in claim 73, wherein the interlocked elongate element is configured to have a groove by folding of the interlocking edge.

75. The unbonded flexible pipe as claimed in claim 50, wherein the pressure armor comprises at least two helically wound elongate and interlocked elements, where one interlocking edge of a winding of a first of the interlocked elongate elements is interlocked to an interlocking edge of an adjacent winding of a second of the interlocked elongate elements, wherein the interlocking edge of a winding of the first of the interlocked elongate elements is configured to have a groove into which the interlocking edge of the adjacent winding of the second of the interlocked elongate elements is arranged.

76. The unbonded flexible pipe as claimed in claim 75, wherein the interlocked elongate element is configured to have a groove by folding of the interlocking edge.

77. The unbonded flexible pipe as claimed in claim 50, wherein the interlocking edges each have an average thickness, determined perpendicular to its respective angle to the planar mid section, wherein the average thickness is equal to or larger than the thickness of the planar mid section,

78. The unbonded flexible pipe as claimed in claim 77, wherein the thickness of the interlocking edges is substantially uniform.

79. The unbonded flexible pipe as claimed in claim 50, wherein the non-interlocked elongate element has a cross-sectional profile and a maximal thickness in the cross-sectional profile determined in radial direction from the axis of the pipe, the maximal thickness of the non-interlocked elongate element is at least about 5 mm.

80. The unbonded flexible pipe as claimed in claim 79, wherein the maximal thickness of the non-interlocked elongate element is from about 5 mm to about 20 mm.

81. The unbonded flexible pipe as claimed in claim 50, wherein the pressure armor comprises a plurality of non-interlocked elongate elements helically wound where the windings of one non-interlocked elongate element are arranged onto windings of another non-interlocked elongate element to provide layered windings of non-interlocked elongate elements, wherein layered windings of the non-interlocked elongate elements are held with a predetermined relative distance to each other by the interlocking edges of the helically wound interlocked elongate element(s).

82. The unbonded flexible pipe as claimed in claim 50, wherein the number of the non-interlocked elongate elements is equal to or larger than the number of interlocked elongate elements.

83. The unbonded flexible pipe as claimed in claim 82, wherein the number of the non-interlocked elongate elements is from 2 times to 4 times the number of interlocked elongate elements.

84. The unbonded flexible pipe as claimed in claim 82, wherein the number of the non-interlocked elongate elements varies along the length of the unbonded flexible pipe.

85. The unbonded flexible pipe as claimed in claim 50, wherein the non-interlocked elongate element(s) has/have a substantially constant cross-sectional profile along at least a part of its length.

86. The unbonded flexible pipe as claimed in claim 50, wherein the non-interlocked elongate element(s) has/have a substantially constant cross-sectional profile along all of its length.

87. The unbonded flexible pipe as claimed in claim 50, wherein the non-interlocked elongate element(s) has/have a cross-sectional profile which is substantially rectangular.

88. The unbonded flexible pipe as claimed in claim 50, wherein the non-interlocked elongate element(s) has/have a cross-sectional profile which is T-shaped or cleaved T-shape (i.e. a left and a right cleaved T-shape provides together a T-shape), along at least a part of its length.

89. The unbonded flexible pipe as claimed in claim 88, wherein the T-shape or cleaved T-shape has a bottom part (the lower most part of the T) and a cross part (the cross line on top of the lower most part of the T), the bottom part protrudes towards the planar mid section of the strip, the cross part comprises at least one end face with a protrusion or a cavity, the protrusion or the cavity of the non-interlocked elongate element is engaged with a protrusion or a cavity in an adjacent winding of the non-interlocked elongate element or with a protrusion or a cavity in an adjacent winding of another non-interlocked elongate element.

90. The unbonded flexible pipe as claimed in claim 50, wherein the non-interlocked elongate element(s) has/have a cross-sectional profile which is T-shaped or cleaved T-shape (i.e. a left and a right cleaved T-shape provides together a T-shape), along all of its length.

91. The unbonded flexible pipe as claimed in claim 90, wherein the T-shape or cleaved T-shape has a bottom part (the lower most part of the T) and a cross part (the cross line on top of the lower most part of the T), the bottom part protrudes towards the planar mid section of the strip, the cross part comprises at least one end face with a protrusion or a cavity, the protrusion or the cavity of the non-interlocked elongate element is engaged with a protrusion or a cavity in an adjacent winding of the non-interlocked elongate element or with a protrusion or a cavity in an adjacent winding of another non-interlocked elongate element.

92. The unbonded flexible pipe as claimed in claim 50, wherein the planar mid section of the strip has a first surface facing towards and supporting the inner sealing sheath, the planar mid section has an average thickness determined in radial direction from the axis of the pipe, the non-interlocked elongate element has a cross-sectional profile and a maximal thickness in the cross-sectional profile determined in radial direction, the maximal thickness of the non-interlocked elongate element is larger than the average thickness of the planar section of the strip.

93. The unbonded flexible pipe as claimed in claim 92, wherein the maximal thickness of the non-interlocked elongate element is at least about 1.5 times the average thickness of the planar section of the strip.

94. The unbonded flexible pipe as claimed in claim 92, wherein the maximal thickness of the non-interlocked elongate element is at least about 2 times to at least about 5 times the average thickness of the planar section of the strip.

95. The unbonded flexible pipe as claimed in claim 81, wherein the planar mid section of the strip has a first surface facing towards and supporting the inner sealing sheath, the planar mid section has an average thickness determined in radial direction from the axis of the pipe, the layered windings of the non-interlocked elongate elements have a cross-sectional profile and a common maximal thickness in the cross-sectional profile determined in radial direction, the common maximal thickness of the layered windings of the non-interlocked elongate element is larger than the average thickness of the planar section of the strip.

96. The unbonded flexible pipe as claimed in claim 95, wherein the maximal thickness of the layered windings of the non-interlocked elongate element is at least about 1.2 times to at least about 5 times the average thickness of the planar section of the strip.

97. The unbonded flexible pipe as claimed in claim 50, wherein the planar mid section of the strip has a first surface facing towards and supporting the inner sealing sheath and a second surface opposite the first surface, wherein the non-interlocked elongate element(s) is/are arranged above and in contact with the second surface, optionally with an intermediate film/foil layer and/or flanges protruding from interlocking element(s).

98. The unbonded flexible pipe as claimed in claim 50, wherein the non-interlocked elongate element(s) is/are wound onto the planar mid section of the strip such that it is placed between the first and the second interlocking bent edges in contact with the planar mid section or in contact with one or more flanges of an interconnecting element, interconnecting edges of interlocked elongate element(s).

99. The unbonded flexible pipe as claimed in claim 50, wherein at least one of the interlocked elongate elements is of duplex-steel.

100. The unbonded flexible pipe as claimed in claim 50, wherein at least one of the interlocked elongate elements is of fiber reinforced polymer.

101. The unbonded flexible pipe as claimed in claim 50, wherein at least one of the interlocked elongate elements is of cured pultruded composite material.

102. The unbonded flexible pipe as claimed in claim 50, wherein the non-interlocked elongate element(s) comprise(s) polymer, selected from elastomer and thermoplast

103. The unbonded flexible pipe as claimed in claim 50, wherein the non-interlocked elongate element(s) is/are of polymer reinforced with reinforcement selected from fibers and particles.

104. The unbonded flexible pipe as claimed in claim 50, wherein the non-interlocked elongate element(s) is/are a pultruded fiber reinforced polymer element.

105. The unbonded flexible pipe as claimed in claim 50, wherein the pressure armor of the unbonded flexible pipe comprises two or more non-interlocked elongate elements placed upon each other.

106. The unbonded flexible pipe as claimed in claim 50, wherein the pressure armor of the unbonded flexible pipe comprises two or more non-interlocked elongate elements placed upon each other in the form of a first elastomer,

107. The unbonded flexible pipe as claimed in claim 50, wherein the windings of the non-interlocked elongate element(s) are held with a predetermined relative distance which can vary between a predetermined maximum distance Dₘₐₓ and a predetermined minimum distance Dₘᵢₙ to each other by the interlocking edges of the helically wound interlocked elongate element(s), wherein 1.1*Dₘᵢₙ≦Dₘₐₓ≦2*Dₘᵢₙ.

108. The unbonded flexible pipe as claimed in claim 109, wherein the non-interlocked elongate element(s) has/have a cross-sectional profile with a thickness determined in radial direction and a maximal width determined perpendicular to the radial direction, wherein the maximal width Wₘₐₓ is larger than the predetermined maximum distance Dₘₐₓ between windings of the non-interlocked elongate element.

109. The unbonded flexible pipe as claimed in claim 50, wherein the windings of the non-interlocked elongate element(s) are held with a predetermined relative distance which can vary between a predetermined maximum distance Dₘₐₓ and a predetermined minimum distance Dₘᵢₙ to each other by the interlocking edges of the helically wound interlocked elongate element(s), and the non-interlocked elongate element(s) has/have a cross-sectional profile with a thickness determined in radial direction and a maximal width Wₘₐₓ determined perpendicular to the radial direction, wherein 1.1*Dₘₐₓ≦Wₘₐₓ≦5*Dₘₐₓ.

110. The unbonded flexible pipe as claimed in claim 50, wherein the windings of the non-interlocked elongate element(s) are held with a predetermined relative distance which can vary between a predetermined maximum distance Dₘₐₓ and a predetermined minimum distance Dₘᵢₙ to each other by the interlocking edges of the helically wound interlocked elongate element(s), and the non-interlocked elongate element(s) has/have a cross-sectional profile with a thickness determined in radial direction and a maximal width determined perpendicular to the radial direction, wherein 1.5*Dₘₐₓ≦Wₜₒₚ≦3*Dₘₐₓ.

111. The unbonded flexible pipe as claimed in claim 109, wherein the non-interlocked elongate element(s) has/have a cross-sectional profile with a thickness determined in radial direction and a top width determined perpendicular to the radial direction at a surface of the non-interlocked elongate element facing away from the inner sealing sheath, wherein the maximal width Wₜₒₚ is larger than the predetermined maximum distance Dₜₒₚ between windings of the non-interlocked elongate element.

112. The unbonded flexible pipe as claimed in claim 50, wherein the non-interlocked elongate element(s) has/have a cross-sectional profile with a thickness determined in radial direction and a width determined perpendicular to the radial direction, wherein the width is substantially constant along the length of the non-interlocked elongate element.

113. The unbonded flexible pipe as claimed in claim 50, wherein the unbonded flexible pipe has two or more length sections, wherein the pressure armor differs from each other in that at least one property, the thickness, the cross-sectional shape(s) and/or the number of non-interlocked elongate elements differs from one section of the unbonded flexible pipe to another section of the unbonded flexible pipe.

114. The unbonded flexible pipe as claimed in claim 113, wherein the at least one helically wound elongate and interlocked element is identical in the two or more sections of the unbonded flexible pipe and at least one helically wound elongate and non-interlocked elongate element is of a different material or material combination from one section to another, the at least one helically wound elongate and non-interlocked elongate element has one or more sampling points where one non-interlocked elongate element section of a first material or material combination is connected to another non-interlocked elongate element section of a first material or material combination.

115. The unbonded flexible pipe as claimed in claim 114, wherein the connection(s) is/are selected from a connecting fitting, glue, nail(s), snap lock(s) or combinations thereof.

116. The unbonded flexible pipe as claimed in claim 50, wherein the unbonded flexible pipe comprises along its length a bottom section adapted to be closer to a sea bottom and a top section adapted to be closer to a sea surface, the pressure armor in the bottom section is heavier per length unit than the pressure armor of the top section.

117. The unbonded flexible pipe as claimed in claim 50, wherein the unbonded flexible pipe comprises one or more mid sections between the bottom section and the top section, the relative weight (weight per length unit) of the pressure armor increases from section to section from the top section to the bottom section.
